(19) United States
(12) Patent Application Publication
(10) Pub. No.: US 2022/0382479 A1
(43) Pub. Date: Dec. 1, 2022

(54) INFORMATION PROCESSING APPARATUS, INFORMATION PROCESSING METHOD, AND INFORMATION PROCESSING PROGRAM

(71) Applicant: FUJIFILM CORPORATION, Tokyo (JP)

(72) Inventors: Michitaka KONDO, Tokyo (JP); Yutaka OISHI, Tokyo (JP); Takashi MIYAMOTO, Tokyo (JP); Terue WATANABE, Tokyo (JP); Koji MATSUMURA, Tokyo (JP); Yuko UNO, Tokyo (JP)

(21) Appl. No.: 17/819,319

(22) Filed: Aug. 12, 2022

Related U.S. Application Data
(63) Continuation of application No. PCT/JP2021/000907, filed on Jan. 13, 2021.

(30) Foreign Application Priority Data
Feb. 28, 2020 (JP) 2020-034304

(51) Int. Cl. G06F 3/06

(52) U.S. Cl. CPC G06F 3/0647; G06F 3/0608; G06F 3/0644; G06F 3/0686

(57) ABSTRACT

An information processing apparatus performs, in a case where an object including at least one of data or metadata related to the data is recorded in a magnetic tape, control of reading one or more object groups and one or more metadata groups recorded in the magnetic tape including a first partition in which one or more objects are to be recorded and a second partition in which pieces of the metadata are to be recorded, and determines, in a case of recording the object groups in the first partition of a certain magnetic tape of a plurality of magnetic tapes different from the magnetic tape and recording the metadata groups in the second partition of the certain magnetic tape, for a set of the one or more object groups and the one or more metadata groups, a magnetic tape as a recording destination of the object groups and the metadata groups, from the plurality of magnetic tapes, according to a ratio between a size of the object groups and a size of the metadata groups.

### CROSS-REFERENCE TO RELATED APPLICATIONS

This application is a continuation application of International Application No. PCT/JP2021/000907, filed on Jan. 13, 2021, the disclosure of which is incorporated herein by reference in its entirety. Further, this application claims priority from Japanese Patent Application No. 2020-034304, filed on Feb. 28, 2020, the disclosure of which is incorporated herein by reference in its entirety.

### BACKGROUND

### 1. Technical Field

The present disclosure relates to an information processing apparatus, an information processing method, and an information processing program.

### 2. Description of the Related Art

A technique of dividing a data partition of a magnetic tape including an index partition and a data partition into a plurality of partitions and reclaiming data recorded in the magnetic tape is disclosed (refer to JP2015-103033A).

In addition, in a case of migrating data from a migration-source magnetic tape to a migration-destination magnetic tape, a technique of recording data recorded in a migration-source magnetic tape in a migration-destination magnetic tape in descending order of access frequency of the data recorded in the migration-source magnetic tape is disclosed (refer to JP2010-152603A).

### SUMMARY

On the other hand, as described in JP2015-103033A, a recent magnetic tape may be divided into partitions, for example, a first partition in which data is to be recorded and a second partition in which metadata related to the data is to be recorded. Further, in such a magnetic tape, a data group is recorded in the first partition, and a metadata group is recorded in the second partition.

In general, a size of the data varies depending on the data. On the other hand, a size of the metadata does not depend on the data, and has a small variation compared to the size of the data. For this reason, in a case of recording, in a new magnetic tape, a set of the data group and the metadata group recorded in the magnetic tape as described above, the following problems may occur.

For example, in a case where relatively large amounts of data of which the size is relatively large and metadata related to the data are recorded in a recording-destination magnetic tape, even though a free capacity exists in the second partition and the metadata can be recorded in the second partition, in some cases, a free capacity does not exist in the first partition, and as a result, the data cannot be recorded in the first partition.

On the other hand, in a case where relatively large amounts of data of which the size is relatively small and metadata related to the data are recorded in a recording-destination magnetic tape, even though a free capacity exists in the first partition and the data can be recorded in the first partition, in some cases, a free capacity does not exist in the second partition, and as a result, the metadata cannot be recorded in the second partition.

In these cases, even though a free capacity exists in any one of the partitions, a free capacity does not exist in the other of the partitions. As a result, a set of the metadata and the data cannot be recorded in the magnetic tape. Thus, the magnetic tape cannot be efficiently used.

The present disclosure has been made in view of the above circumstances, and an object of the present disclosure is to provide an information processing apparatus, an information processing method, and an information processing program capable of efficiently using a magnetic tape.

According to an aspect of the present disclosure, there is provided an information processing apparatus including: at least one processor, in which the processor is configured to perform, in a case where an object including at least one of data or metadata related to the data is recorded in a magnetic tape, control of reading one or more object groups and one or more metadata groups recorded in the magnetic tape including a first partition in which one or more objects are to be recorded and a second partition in which pieces of the metadata are to be recorded, and determine, in a case of recording the object groups in the first partition of a certain magnetic tape of a plurality of magnetic tapes different from the magnetic tape and recording the metadata groups in the second partition of the certain magnetic tape, for a set of the one or more object groups and the one or more metadata groups, a magnetic tape as a recording destination of the object groups and the metadata groups, from the plurality of magnetic tapes, according to a ratio between a size of the object groups and a size of the metadata groups.

In the information processing apparatus according to the aspect of the present disclosure, the processor may be configured to determine the magnetic tape as a recording destination of the object groups and the metadata groups such that, for at least one magnetic tape of the plurality of magnetic tapes, among all of the object groups and all of the metadata groups recorded in a migration-source magnetic tape, a ratio between a total size of the object groups to be recorded in the at least one magnetic tape and a total size of the metadata groups to be recorded in the at least one magnetic tape is a ratio between a size of the first partition of the at least one magnetic tape and a size of the second partition of the at least one magnetic tape.

Further, according to another aspect of the present disclosure, there is provided an information processing method executed by a processor of an information processing apparatus, the method including: performing, in a case where an object including at least one of data or metadata related to the data is recorded in a magnetic tape, control of reading one or more object groups and one or more metadata groups recorded in the magnetic tape including a first partition in which one or more objects are to be recorded and a second partition in which pieces of the metadata are to be recorded; and determining, in a case of recording the object groups in the first partition of a certain magnetic tape of a plurality of magnetic tapes different from the magnetic tape and recording the metadata groups in the second partition of the certain magnetic tape, for a set of the one or more object groups and the one or more metadata groups, a magnetic tape as a recording destination of the object groups and the metadata groups, from the plurality of magnetic tapes, according to a ratio between a size of the object groups and a size of the metadata groups.

Further, according to still another aspect of the present disclosure, there is provided an information processing program for causing a processor of an information processing apparatus to execute a process including: performing, in a case where an object including at least one of data or metadata related to the data is recorded in a magnetic tape, control of reading one or more object groups and one or more metadata groups recorded in the magnetic tape including a first partition in which one or more objects are to be recorded and a second partition in which pieces of the metadata are to be recorded; and determining, in a case of recording the object groups in the first partition of a certain magnetic tape of a plurality of magnetic tapes different from the magnetic tape and recording the metadata groups in the second partition of the certain magnetic tape, for a set of the one or more object groups and the one or more metadata groups, a magnetic tape as a recording destination of the object groups and the metadata groups, from the plurality of magnetic tapes, according to a ratio between a size of the object groups and a size of the metadata groups.

According to the present disclosure, the magnetic tape can be efficiently used.

### BRIEF DESCRIPTION OF THE DRAWINGS

FIG. 1 is a block diagram illustrating an example of a configuration of a recording and reproducing system.

FIG. 2 is a diagram for explaining an object.

FIG. 3 is a schematic diagram illustrating an example of a magnetic tape.

FIG. 4 is a diagram illustrating an example of data migration of a magnetic tape.

FIG. 5 is a diagram for explaining a timing for recording metadata.

FIG. 6 is a diagram for explaining a ratio between a size of a metadata group and a size of an object group.

FIG. 7 is a block diagram illustrating an example of a hardware configuration of an information processing apparatus.

FIG. 8 is a block diagram illustrating an example of a functional configuration of the information processing apparatus.

FIG. 9 is a diagram for explaining processing of determining a migration-destination magnetic tape.

FIG. 10 is a flowchart illustrating an example of object migration processing.

FIG. 11 is a schematic diagram for explaining an order of recording data and metadata according to a modification example.

### DETAILED DESCRIPTION

Hereinafter, an example of an embodiment for performing a technique according to the present disclosure will be described in detail with reference to the drawings.

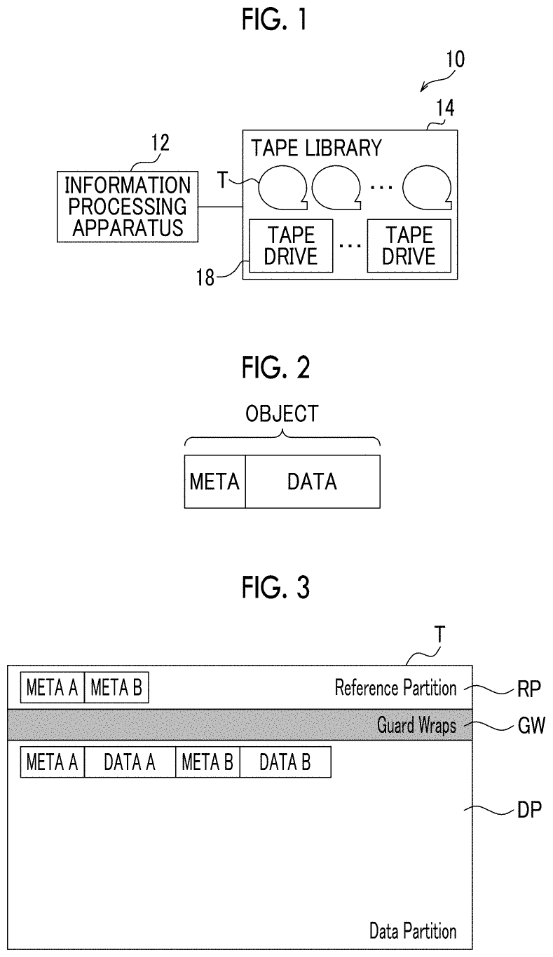

First, a configuration of a recording and reproducing system 10 according to the present embodiment will be described with reference to FIG. 1. As illustrated in FIG. 1, the recording and reproducing system 10 includes an information processing apparatus 12 and a tape library 14.

The tape library 14 includes a plurality of slots (not illustrated) and a plurality of tape drives 18, and each slot includes a magnetic tape T as an example of a recording medium. Each tape drive 18 is connected to the information processing apparatus 12. Examples of the magnetic tape T include a linear tape-open (LTO) tape.

In a case where the information processing apparatus 12 writes or reads data to or from the magnetic tape T, the magnetic tape T as a write target or a read target is loaded from the slot into a predetermined tape drive 18. In a case where data is written or read to and from the magnetic tape T loaded into the tape drive 18, the magnetic tape T is unloaded from the tape drive 18 into the slot in which the magnetic tape T is originally included.

In the present embodiment, as an example, as illustrated in FIG. 2, as a unit for handling data to be recorded in the magnetic tape T, an example of an embodiment in which an object including data to be saved by a user such as document data and image data and metadata related to the data is applied will be described. In the example of FIG. 2, the metadata is referred to as “meta”. A storage system that handles the object is called an object storage system. The metadata includes, for example, object identification information such as an object identifier (ID), data identification information such as a data name, a size of data, and attribute information such as a time stamp.

Next, a configuration of the magnetic tape T according to the present embodiment will be described with reference to FIG. 3. As illustrated in FIG. 3, in a case where the magnetic tape T is formatted, the magnetic tape T is divided into two partitions, a reference partition RP in which the metadata is to be recorded and a data partition DP in which the object is to be recorded. As illustrated in FIG. 3, in the present embodiment, in a case where an object is recorded in the data partition DP, the object is recorded in order of the metadata and the data. Further, the reference partition RP and the data partition DP are separated by guard wraps GW including a plurality of wraps. The data partition DP is an example of a first partition according to the technique of the present disclosure, and the reference partition RP is an example of a second partition according to the technique of the present disclosure. In the object group recorded in the data partition DP of the magnetic tape T, an object including only the data among the data and the metadata may exist, or an object including only the metadata among the data and the metadata may exist.

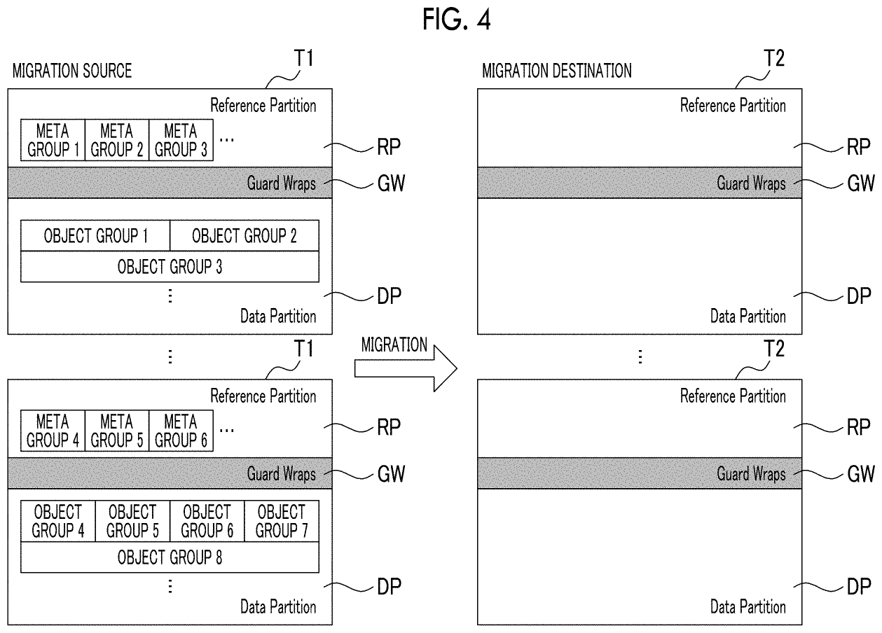

In the present embodiment, as illustrated in FIG. 4, an example of migrating an object from a plurality of magnetic tapes Ts in which objects are recorded to a plurality of new magnetic tapes T in which an object is not recorded will be described. In the following, in a case of distinguishing a magnetic tape T as an object migration source and a magnetic tape T as an object migration destination, the migration-source magnetic tape T is referred to as “magnetic tape T1”, and the migration-destination magnetic tape T is referred to as “magnetic tape T2”. The object migration is performed, for example, due to an end of a useful life of the magnetic tape T1, a release of a magnetic tape T of a new standard, or the like. The number of the magnetic tapes T1 and the number of the magnetic tapes T2 may be the same, or may be different.

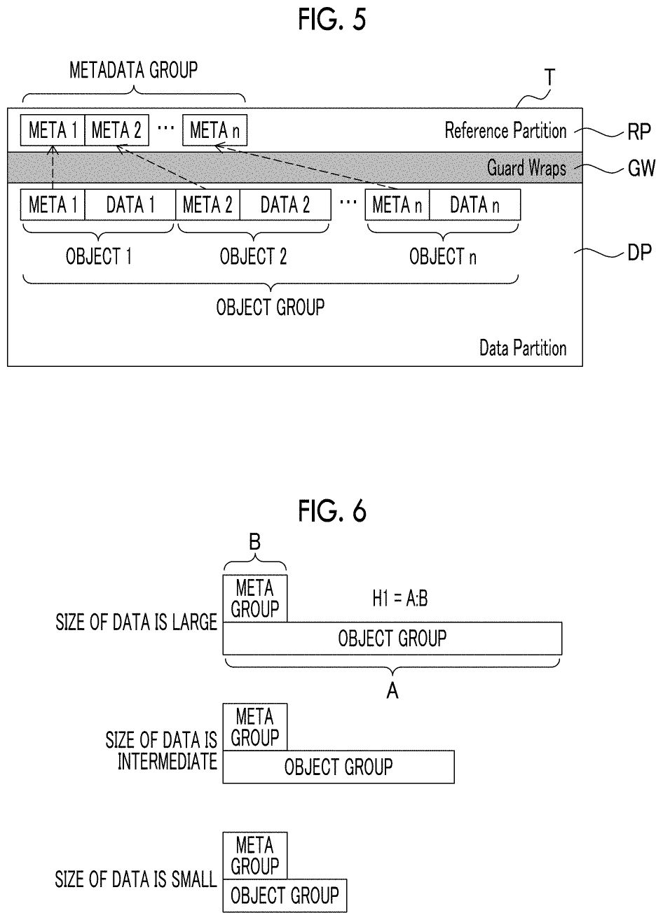

Further, in the present embodiment, as illustrated in FIG. 5, every time a certain number of objects are recorded in the data partition DP of the magnetic tape T, pieces of the metadata of each of the certain number of objects are recorded in the reference partition RP of the magnetic tape T. In the following, the certain number of objects are referred to as an “object group”, and the certain number of pieces of the metadata recorded in the reference partition RP corresponding to the object group are referred to as a “metadata group”. In FIG. 4 and FIG. 5, “metadata” is referred to as “meta”. This notation is the same in the following figures.

In general, a size of the data varies depending on the data. On the other hand, a size of the metadata does not depend on the data, and has a small variation compared to the size of the data. For this reason, as an example, as illustrated in FIG. 6, a ratio H1 between a size of the object group and a size of the metadata group differs depending on a size of the data included in the object group. In FIG. 6, a horizontal length represents the size of the object group and the size of the metadata group. Further, in FIG. 6, an upper part represents an example in which the size of the data is relatively large, a lower part represents an example in which the size of the data is relatively small, and a middle part represents an example in which the size of the data is intermediate between the upper part and the lower part.

In the magnetic tape T in which a plurality of object groups are recorded as described above, in a case where the objects are migrated without considering the ratio H1 and a ratio H2 between the size of the data partition DP and the size of the reference partition RP, the following problems may occur.

For example, in a case where only a group of objects each of which the size of the data is relatively large is recorded in a specific magnetic tape T2, in the magnetic tape T2, the reference partition RP has a free capacity, but the data partition DP may not have free capacity. In this case, an object cannot be recorded in the magnetic tape T2.

On the other hand, in a case where only a group of objects each of which the size of the data is relatively small is recorded in a specific magnetic tape T2, in the magnetic tape T2, the data partition DP has a free capacity, but the reference partition RP may not have free capacity. In this case, an object cannot be recorded in the magnetic tape T2.

In these cases, the magnetic tape T cannot be efficiently used. For this reason, in the present embodiment, which of the plurality of magnetic tapes T2 is used as a recording destination of the object group and the metadata group is determined according to the ratio H1 between the size of the object group and the size of the corresponding metadata group, the object group and the metadata group being recorded in each magnetic tape T1. This problem may also occur even in a case where a variation in the size of the data is smaller than a variation in the size of the metadata.

The metadata group may be recorded in the reference partition RP every time an object group having a certain size is recorded in the data partition DP. The tape drive 18 has a data compression function. Thus, even in a case where an instruction to record a metadata group is input from the information processing apparatus 12 to the tape drive 18 every time an object group having a certain size is recorded, the ratio H1 in the magnetic tape T differs depending on a compression rate. Therefore, even in this case, the above problem may occur.

Further, every time a certain time is elapsed, the metadata group included in the object group recorded in the data partition DP may be recorded in the reference partition RP. The objects recorded in the magnetic tape T may differ depending on a time zone. Even in this case, the above problem may occur.

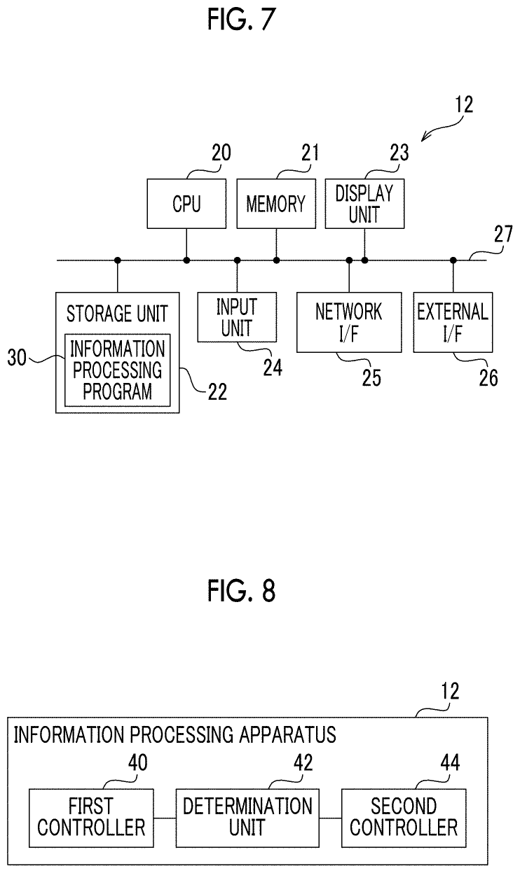

Next, a hardware configuration of the information processing apparatus 12 according to the present embodiment will be described with reference to FIG. 7. As illustrated in FIG. 7, the information processing apparatus 12 includes a central processing unit (CPU) 20, a memory 21 as a temporary memory area, and a non-volatile storage unit 22. Further, the information processing apparatus 12 includes a display unit 23 such as a liquid crystal display, an input unit 24 such as a keyboard and a mouse, a network interface (I/F) 25 connected to a network, and an external I/F 26 to which the tape drive 18 is connected. The CPU 20, the memory 21, the storage unit 22, the display unit 23, the input unit 24, the network I/F 25, and the external I/F 26 are connected to a bus 27.

The storage unit 22 is realized by a hard disk drive (HDD), a solid state drive (SSD), a flash memory, or the like. An information processing program 30 is stored in the storage unit 22 as a storage medium. The CPU 20 reads the information processing program 30 from the storage unit 22, develops the read information processing program 30 in the memory 21, and executes the developed information processing program 30. Examples of the information processing apparatus 12 include a server computer and the like.

Next, a functional configuration of the information processing apparatus 12 according to the present embodiment will be described with reference to FIG. 8. As illustrated in FIG. 8, the information processing apparatus 12 includes a first controller 40, a determination unit 42, and a second controller 44. In a case where the CPU 20 executes the information processing program 30, the information processing apparatus 12 functions as the first controller 40, the determination unit 42, and the second controller 44.

The first controller 40 performs control of reading the metadata groups recorded in the reference partitions RPs of all the migration-source magnetic tapes T1. By the control, the first controller 40 acquires the metadata groups recorded in the reference partitions RPs of all the magnetic tapes T1 by reading the metadata groups by the tape drive 18. The first controller 40 specifies, by using the acquired metadata groups, a size of the object groups recorded in the data partitions DPs of all the migration-source magnetic tapes T1 and a size of the metadata groups that correspond to the object groups and are recorded in the reference partitions RPs of all the migration-source magnetic tapes T1. The size of the object groups can be obtained from pieces of data size information included in the metadata groups.

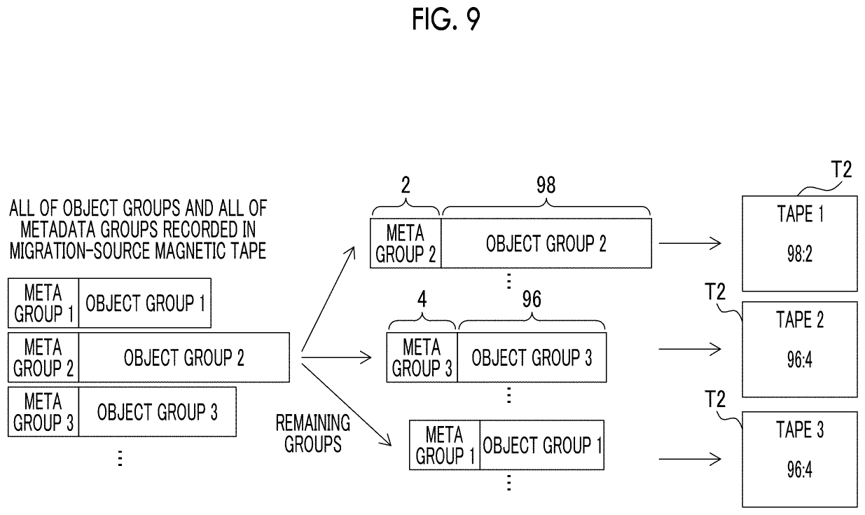

The determination unit 42 determines, for a set of each object group and each metadata group, a magnetic tape T2 as a recording destination of the object group and the metadata group, from the plurality of magnetic tapes T2, according to the ratio H1 between the size of the object groups and the size of the metadata groups. A specific example of this processing will be described with reference to FIG. 9.

The determination unit 42 determines some magnetic tapes T2 in which the object groups and the metadata groups are to be recorded as a whole, from a total size of the object groups and the metadata groups recorded in each magnetic tape T1 and a size of each magnetic tape T2. Here, the total size of the object groups and the metadata groups recorded in each magnetic tape T1 means a total value of the sizes of all the object groups and the metadata groups. Further, a size of the magnetic tape T2 means a total value of the size of the data partition DP and the size of the reference partition RP.

For example, in a case where the total size of the object groups and the metadata groups is 500 TB, the number of the magnetic tapes T2 is 3, and the size of each of the three magnetic tapes T2 is 200 TB, the determination unit 42 determines two magnetic tapes T2, as the magnetic tapes T2 in which the object groups and the metadata groups are to be recorded as a whole. In this case, the object groups and the metadata groups are recorded in approximately half of the entire area of the remaining one magnetic tape T2. In the following, the magnetic tape T2 in which the object groups and the metadata groups are to be recorded as a whole is referred to as “first magnetic tape T2”, and the remaining magnetic tape T2 is referred to as “second magnetic tape T2”. In the example of FIG. 9, the first magnetic tapes T2 are two magnetic tapes “tape 1” and “tape 2”, and the second magnetic tape T2 is one magnetic tape “tape 3”. The number of the first magnetic tapes T2 and the number of the second magnetic tapes T2 are not limited to the example of FIG. 9. For example, the number of the second magnetic tapes T2 may be two or more instead of one.

Next, the determination unit 42 determines, from all the object groups and all the metadata groups recorded in magnetic tapes T1, the magnetic tape T2 as a recording destination of the object groups and the metadata groups such that a ratio H1 in the first magnetic tape T2 between the total size of the object groups to be recorded and the total size of the metadata groups to be recorded is a ratio H2 in the first magnetic tape T2 between the size of the data partition DP and the size of the reference partition RP. FIG. 9 illustrates an example in which a ratio H2 in the magnetic tape T2 “tape 1” is “98:2” and a ratio H2 in the magnetic tapes T2 “tape 2” and “tape 3” is “96:4”. The ratio H2 in each magnetic tape T2 may be the same.

Specifically, the determination unit 42 determines a combination of the plurality of the object groups and the metadata groups in which the ratio H1 is the ratio H2 in each of the first magnetic tapes T2, from all the object groups and all the metadata groups recorded in the magnetic tapes T1, the plurality of the object groups and the metadata groups satisfying the following conditions. In this case, the determination unit 42 further determines a combination of the plurality of the object groups and the metadata groups in which a total value of the total size of the object groups and the total size of the metadata groups is equal to or larger than a predetermined ratio (for example, 98%) of the size of the first magnetic tape T2 and equal to or smaller than the size of the first magnetic tape T2. In the example of FIG. 9, the determination unit 42 determines a combination of the plurality of the object groups and the metadata groups in which the ratio H1 is “98:2” and the total value is equal to or larger than 98% of the size of the first magnetic tape “tape 1” and equal to or smaller than the size of the first magnetic tape “tape 1”. In this case, the determination unit 42 determines a recording destination of the determined combination of the plurality of the object groups and the metadata groups, as the first magnetic tape “tape 1”. Further, in the example of FIG. 9, the determination unit 42 also determines a combination of the plurality of the object groups and the metadata groups in which the ratio H1 is “96:4” and the total value is equal to or larger than 98% of the size of the first magnetic tape “tape 2” and equal to or smaller than the size of the first magnetic tape “tape 2”. In this case, the determination unit 42 determines a recording destination of the determined combination of the plurality of the object groups and the metadata groups, as the first magnetic tape “tape 2”. It is assumed that there is no duplication in the object groups and the metadata groups included in these combinations.

The determination unit 42 determines the corresponding first magnetic tape T2 as a recording-destination magnetic tape T2 for each object group and each metadata group included in the determined combination of the plurality of the object groups and the metadata groups. In this case, the ratio H1 in the combination of the plurality of the object groups and the metadata groups may not exactly match the ratio H2 in the first magnetic tape T2. The ratio H1 in the combination of the plurality of object groups and the metadata groups may be included in a range obtained by adding a predetermined margin to the ratio H2 in the first magnetic tape T2. More specifically, in the example of the magnetic tape “tape 1” in FIG. 9, the ratio H1 in the combination of the plurality of the object groups and the metadata groups may be 97.9:2.1.

Further, the determination unit 42 determines a second magnetic tape T2 as a recording-destination magnetic tape T2 for the remaining object groups and the remaining metadata groups other than the object groups and the metadata groups for which the recording-destination magnetic tape T2 is determined as described above. For this reason, in the second magnetic tape T2, a difference between the ratio H1 in the object groups and the metadata groups to be recorded and the ratio H2 in the second magnetic tape T2 may be relatively large. On the other hand, since the second magnetic tape T2 has a free capacity, after the migration is performed, the ratio H1 in the object groups and the metadata groups to be added to the second magnetic tape T2 may be taken into consideration. Thereby, the ratio H1 in the object groups and the metadata groups recorded in the second magnetic tape T2 after the migration can be brought close to the ratio H2. Therefore, the magnetic tape T2 can be efficiently used.

The second controller 44 performs control of reading all the object groups and all the metadata groups recorded in each magnetic tape T1. The second controller 44 performs control of recording each set of all the object groups and all the metadata groups in the magnetic tape T2 determined by the determination unit 42.

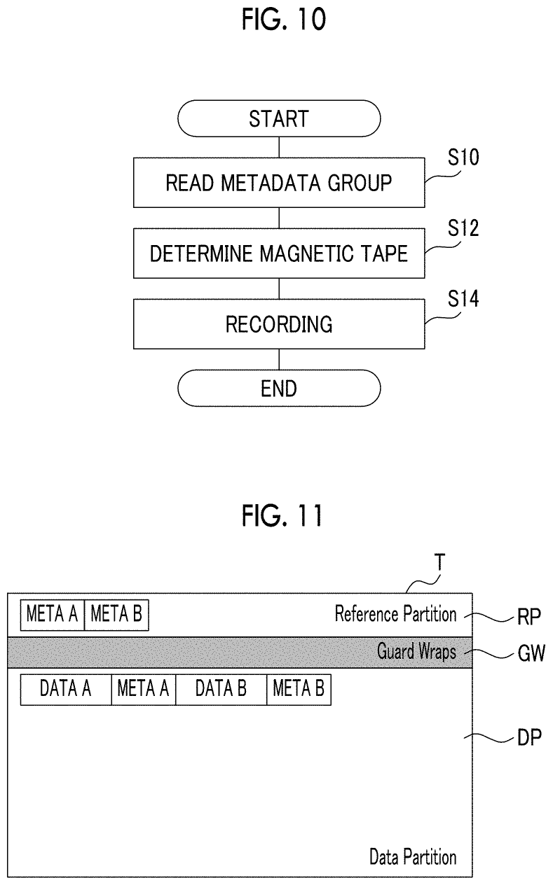

Next, an operation of the information processing apparatus 12 according to the present embodiment will be described with reference to FIG. 10. In a case where the CPU 20 executes the information processing program 30, object migration processing illustrated in FIG. 10 is executed. The object migration processing illustrated in FIG. 10 is executed, for example, in a case where an execution instruction is input by the user via the input unit 24.

In step S10 of FIG. 10, as described above, the first controller 40 performs control of reading the metadata groups recorded in the reference partitions RPs of all the migration-source magnetic tapes T1. In step S12, as described above, the determination unit 42 determines, by using the metadata groups read in step S10, for a set of each object group and each metadata group, a magnetic tape T2 as a recording destination of the object group and the metadata group, from the plurality of magnetic tapes T2, according to the ratio H1 between the size of the object groups and the size of the metadata groups.

In step 514, the second controller 44 performs control of reading all the object groups and all the metadata groups recorded in each magnetic tape T1. The second controller 44 performs control of recording each set of all the object groups and all the metadata groups in the magnetic tape T2 determined in step S12.

As described above, according to the present embodiment, for each set of the object groups and the metadata groups recorded in each magnetic tape T1, a magnetic tape T2 as a recording destination of the object groups and the metadata groups is determined, from the plurality of magnetic tapes T2, according to the ratio H1 between the size of the object groups and the size of the metadata groups. Therefore, the magnetic tape T2 can be efficiently used.

In the embodiments, in a case where the information processing apparatus 12 records the object in the data partition DP of the magnetic tape T, a case where the object is recorded in order of the metadata and the data has been described (refer to FIG. 3). On the other hand, the present disclosure is not limited thereto. For example, as illustrated in FIG. 11, in a case where the information processing apparatus 12 records the object in the data partition DP of the magnetic tape T, the object may be recorded in order of the data and the metadata.

Further, in the embodiment, for example, as a hardware structure of a processing unit that executes various processing such as the first controller 40, the determination unit 42, and the second controller 44, the following various processors may be used. The various processors include, as described above, a CPU which is a general-purpose processor that functions as various processing units by executing software (program), and a dedicated electric circuit which is a processor having a circuit configuration specifically designed to execute specific processing, such as a programmable logic device (PLD) or an application specific integrated circuit (ASIC) that is a processor of which the circuit configuration may be changed after manufacturing such as a field programmable gate array (FPGA).

One processing unit may be configured by one of these various processors, or may be configured by a combination of two or more processors of the same type or different types (for example, a combination of a plurality of FPGAs or a combination of a CPU and an FPGA). Further, the plurality of processing units may be configured by one processor.

As an example in which the plurality of processing units are configured by one processor, firstly, as represented by a computer such as a client and a server, a form in which one processor is configured by a combination of one or more CPUs and software and the processor functions as the plurality of processing units may be adopted. Secondly, as represented by a system on chip (SoC) or the like, a form in which a processor that realizes the function of the entire system including the plurality of processing units by one integrated circuit (IC) chip is used may be adopted. As described above, the various processing units are configured by using one or more various processors as a hardware structure.

Further, as the hardware structure of the various processors, more specifically, an electric circuit (circuitry) in which circuit elements such as semiconductor elements are combined may be used.

Further, in the embodiment, an example in which the information processing program 30 is stored (installed) in the storage unit 22 in advance has been described. On the other hand, the present disclosure is not limited thereto. The information processing program 30 may be provided by being recorded in a recording medium such as a compact disc read only memory (CD-ROM), a digital versatile disc read only memory (DVD-ROM), or a Universal Serial Bus (USB) memory. Further, the information processing program 30 may be downloaded from an external apparatus via a network.

In the disclosure of Japanese Patent Application No. 2020-034304, filed Feb. 28, 2020, the entire contents of which are incorporated herein by reference. Further, all documents, patent applications, and technical standards mentioned in this specification are incorporated herein by reference to the same extent as in a case where each document, each patent application, and each technical standard are specifically and individually described by being incorporated by reference.

What is claimed is:

1. An information processing apparatus comprising:
at least one processor,
wherein the processor is configured to
perform, in a case where an object including at least one of data or metadata related to the data is recorded in a magnetic tape, control of reading one or more object groups and one or more metadata groups recorded in the magnetic tape including a first partition in which one or more objects are to be recorded and a second partition in which pieces of the metadata are to be recorded, and
determine, in a case of recording the object groups in the first partition of a certain magnetic tape of a plurality of magnetic tapes different from the magnetic tape and recording the metadata groups in the second partition of the certain magnetic tape, for a set of the one or more object groups and the one or more metadata groups, a magnetic tape as a recording destination of the object groups and the metadata groups, from the plurality of magnetic tapes, according to a ratio between a size of the object groups and a size of the metadata groups.

2. The information processing apparatus according to claim 1,
wherein the processor is configured to determine the magnetic tape as a recording destination of the object groups and the metadata groups such that, for at least one magnetic tape of the plurality of magnetic tapes, among all of the object groups and all of the metadata groups recorded in a migration-source magnetic tape, a ratio between a total size of the object groups to be recorded in the at least one magnetic tape and a total size of the metadata groups to be recorded in the at least one magnetic tape is a ratio between a size of the first partition of the at least one magnetic tape and a size of the second partition of the at least one magnetic tape.

3. An information processing method executed by a processor of an information processing apparatus, the method comprising:
performing, in a case where an object including at least one of data or metadata related to the data is recorded in a magnetic tape, control of reading one or more object groups and one or more metadata groups recorded in the magnetic tape including a first partition in which one or more objects are to be recorded and a second partition in which pieces of the metadata are to be recorded; and
determining, in a case of recording the object groups in the first partition of a certain magnetic tape of a plurality of magnetic tapes different from the magnetic tape and recording the metadata groups in the second partition of the certain magnetic tape, for a set of the one or more object groups and the one or more metadata groups, a magnetic tape as a recording destination of the object groups and the metadata groups, from the plurality of magnetic tapes, according to a ratio between a size of the object groups and a size of the metadata groups.

4. The information processing method according to claim 3, the method further comprising:
determining the magnetic tape as a recording destination of the object groups and the metadata groups such that, for at least one magnetic tape of the plurality of magnetic tapes, among all of the object groups and all of the metadata groups recorded in a migration-source magnetic tape, a ratio between a total size of the object groups to be recorded in the at least one magnetic tape and a total size of the metadata groups to be recorded in the at least one magnetic tape is a ratio between a size of the first partition of the at least one magnetic tape and a size of the second partition of the at least one magnetic tape.

5. A non-transitory computer-readable storage medium storing an information processing program for causing a processor of an information processing apparatus to execute a process comprising:
performing, in a case where an object including at least one of data or metadata related to the data is recorded in a magnetic tape, control of reading one or more object groups and one or more metadata groups recorded in the magnetic tape including a first partition in which one or more objects are to be recorded and a second partition in which pieces of the metadata are to be recorded; and
determining, in a case of recording the object groups in the first partition of a certain magnetic tape of a plurality of magnetic tapes different from the magnetic tape and recording the metadata groups in the second partition of the certain magnetic tape, for a set of the one or more object groups and the one or more metadata groups, a magnetic tape as a recording destination of the object groups and the metadata groups, from the plurality of magnetic tapes, according to a ratio between a size of the object groups and a size of the metadata groups.

6. The non-transitory computer-readable storage medium storing the information processing program according to claim 5, the process further comprising:
determining the magnetic tape as a recording destination of the object groups and the metadata groups such that, for at least one magnetic tape of the plurality of magnetic tapes, among all of the object groups and all of the metadata groups recorded in a migration-source magnetic tape, a ratio between a total size of the object groups to be recorded in the at least one magnetic tape and a total size of the metadata groups to be recorded in the at least one magnetic tape is a ratio between a size of the first partition of the at least one magnetic tape and a size of the second partition of the at least one magnetic tape.
